(19) United States
(12) Patent Application Publication
(10) Pub. No.: US 2012/0303987 A1
(43) Pub. Date: Nov. 29, 2012

(54) ENERGY CONTROL APPARATUS AND METHOD USING PROPERTY OF ELECTRONIC DEVICE

(75) Inventors: Kye Seon Lee, Daejeon (KR); Jong Arm Jun, Daejeon (KR); Yoon Mee Doh, Daejeon (KR)

(73) Assignee: Electronics and Telecommunications Research Institute, Daejeon (KR)

(21) Appl. No.: 13/481,783

(22) Filed: May 26, 2012

(30) Foreign Application Priority Data
May 27, 2011 (KR) 2011-0050741

(51) Int. Cl. G06F 1/32

(52) U.S. Cl. 713/320

(57) ABSTRACT

An energy control apparatus and method using a usage property of an electronic device. The energy control method may include: setting a total power consumption to be less than a predetermined threshold; verifying a usage property for each electronic device when a collected total power consumption exceeds the threshold; calculating a scheduled end time based on the average usage time of each remaining electronic device excluding, from among operating devices, an electronic device of which power-off is unavailable; verifying a remaining electronic device excluding an electronic device of which scheduled end time is less than the threshold; controlling a temporarily stoppable electronic device to be temporarily stopped; controlling a power adjustable electronic device to decrease a power consumption when the total power consumption exceeds the threshold; and starting the temporarily stopped electronic device at a point in time when the total power consumption decreases to be less than the threshold.

### CROSS-REFERENCE TO RELATED APPLICATION

This application claims the priority benefit of Korean Patent Application No. 10-2011-0050741, filed on May 27, 2011, in the Korean Intellectual Property Office, the disclosure of which is incorporated herein by reference.

### BACKGROUND

1. Field of the Invention

Embodiments of the present invention relate to an apparatus and method for controlling energy based on a usage property of an electronic device.

2. Description of the Related Art

A management system for energy saving may be a sub meter including a sub metering function of reading a power consumption amount of an electronic device that is installed within a house or an office building. The power consumption amount measured by the sub meter may be used by a variety of methods. In particular, the measured power consumption amount may be used by a method of constructing an energy management server within a building to control whether to use an electronic device based on a power consumption amount for each electronic device. In the conventional energy management system, information collected from the sub meter may be limited to a power consumption amount for each electronic device.

However, a usage property of an electronic device may be different based on a type of the electronic device. According to a power consumption pattern provided from the Power Exchange, a major usage time and a power consumption rate are different, which can be verified from the number of electronic devices used and a ratio thereof for each time zone. Referring to a standard consumption pattern of electronic devices, it can be known that a consumption pattern is significantly different for each electronic device. For example, an electric rice cooker consumes a constant amount of electric power at all times without power-off.

As an example of using information collected through sub metering, when a total power amount consumed in a building exceeds a predetermined rate, an energy management system within the building may transmit a warning notice using a display apparatus. As another example, a user may be enabled to selectively cut off power by displaying a power consumption amount for each electronic device on the display apparatus.

However, as described above, an energy management server does not consider an aspect that each of electronic devices may have a different usage property and thus, may have some constraints in saving energy. Accordingly, there is a desire for a system that may control energy based on a property of each electronic device.

### SUMMARY

An aspect of the present invention provides an energy control apparatus and method using a usage property of an electronic device that may control an amount of power consumed by an electronic device installed within a building, based on a usage property of the electronic device.

According to an aspect of the present invention, there is provided an energy control apparatus using a usage property of an electronic device, the apparatus including: a decision module to determine whether to control power of the electronic device by calculating a remaining operation time excluding an actual operation time from the average usage time; and a control module to control at least one of power-off, adjustment of power consumption, and a restart in a power available time zone after a temporary stop with respect to the electronic device, based on the determination result.

According to another aspect of the present invention, there is provided an energy control apparatus using a usage property of an electronic device, the apparatus including: setting a total power consumption amount to be a value less than a predetermined threshold value; verifying a usage property for each electronic device when a collected total power consumption amount exceeds the threshold value; calculating a scheduled end time based on the average usage time of each remaining electronic device excluding, from among operating electronic devices, an electronic device of which power-off is unavailable; verifying a remaining electronic device excluding an electronic device of which scheduled end time is lees than the threshold value; controlling a temporarily stoppable electronic device to be temporarily stopped; controlling a power adjustable electronic device to decrease a power consumption amount when the total power consumption amount after the temporary stop exceeds the threshold value; and starting the temporarily stopped electronic device at a point in time when the total power consumption amount after decreasing the power consumption amount decreases to be less than the threshold value.

### EFFECT OF THE INVENTION

According to embodiments of the present invention, it is possible to control energy consumption by collecting and analyzing a power consumption amount of each electronic device installed within a building, and then managing energy consumption, and by reflecting a usage property for each electronic device.

According to embodiments of the present invention, it is possible to selectively and efficiently control an electronic device based on the average usage time by automatically powering off the electronic device at a point in time when energy saving is required, by adjusting a temperature of an air conditioning and heating device or a brightness of an illumination, or by temporarily stopping and then restarting the electronic device.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a configuration of an energy control system according to an embodiment of the present invention;

FIG. 2 is a table illustrating an example of electronic devices classified by an energy control apparatus according to an embodiment of the present invention;

FIG. 3 is a block diagram illustrating a configuration of an energy control apparatus according to an embodiment of the present invention;

FIG. 4 is a table illustrating a usage property for each electronic device according to an embodiment of the present invention;

FIG. 5 is a flowchart illustrating an energy control method according to an embodiment of the present invention; and

FIG. 6 is a table illustrating a usage time of each electronic device according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

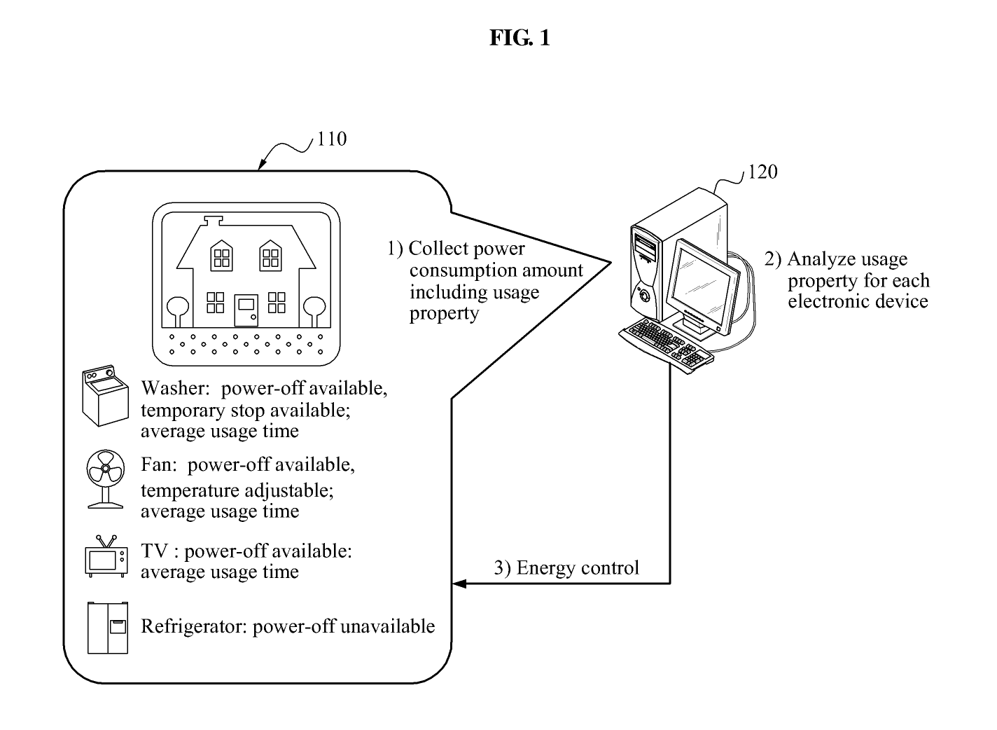

FIG. 1 is a diagram illustrating a configuration of an energy control system according to an embodiment of the present invention.

Referring to FIG. 1, the energy control system may include electronic devices 110 being installed within a house to provide various types of services, and an energy control apparatus 120 to collect a power consumption amount for each electronic device 110, to analyze a usage property of each electronic device 110, and to thereby control energy consumption.

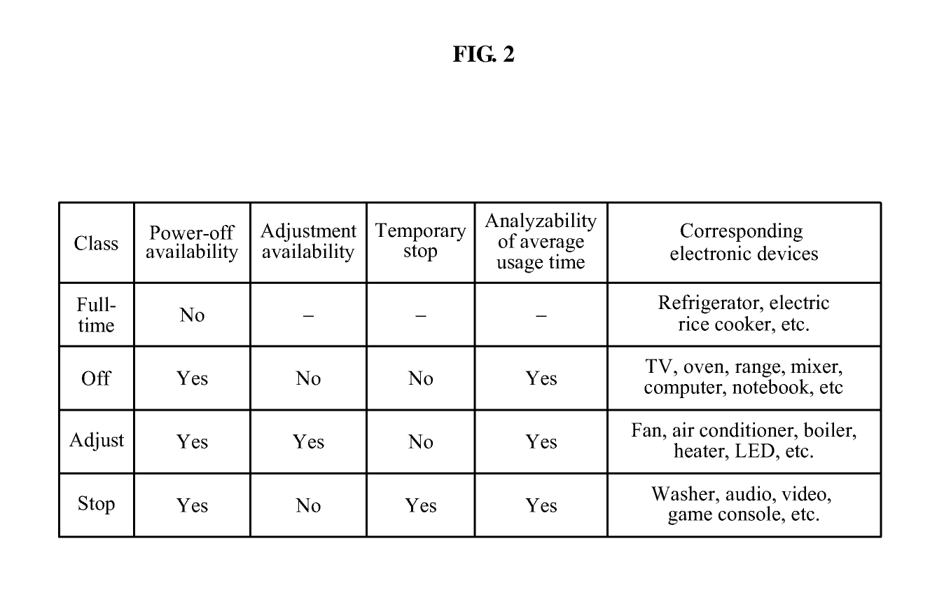

The energy control apparatus 120 may classify the electronic devices 110 as shown in FIG. 2, based on a usage property. The electronic devices 110 of FIG. 1 may be classified as shown in the table of FIG. 2 based on a usage property of each electronic device 110.

FIG. 2 is a table illustrating an example of electronic devices classified by an energy control apparatus according to an embodiment of the present invention.

In the case of electronic devices to be supplied with power at all times, such as a refrigerator, an electric rice cooker, and the like, power-off for energy saving may not be performed. Therefore, such electronic devices may not be affected by a usage property such as a power adjustment availability or whether the average usage time is collected. That is, with respect to the electronic devices that are provided with power at a full time, the energy control apparatus may only collect a power consumption amount for power consumption analysis, and may not perform a control such as power-off and the like.

In the case of electronic devices capable of being powered off such as a television (TV), an oven, and the like, when a power consumption amount within a building exceeds a predetermined threshold value, such electronic devices may be powered off by the energy control apparatus.

In the case of power-adjustable electronic devices such as an air conditioning and heating device, an illumination, and the like, when a power consumption amount within a building exceeds a predetermined threshold value, a temperature or a brightness of such electronic devices may be adjusted by the energy control apparatus. Through this, the power consumption may be adjusted.

In the case of temporarily stoppable electronic devices such as a washer, an audio, and the like, when a power consumption amount within a building exceeds a predetermined threshold value, such electronic devices may be temporarily stopped by the energy control apparatus and then be restarted when the power consumption amount becomes flexible. The energy control apparatus may protect the continuity of an operation by controlling stop/restart with respect to an electronic device.

A power consumption control method by the above-described energy control apparatus may include all the methods of automatically performing power-off, a power adjustment, a temporary stop, and the like. For example, the power consumption control method may include a method of manipulating power of a predetermined electronic device using a display apparatus.

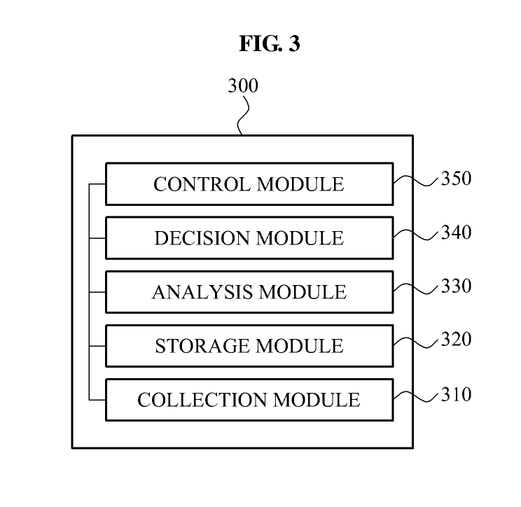

FIG. 3 is a block diagram illustrating a configuration of an energy control apparatus 300 according to an embodiment of the present invention.

Referring to FIG. 3, the energy control apparatus 300 may include a collection module 310, a storage module 320, an analysis module 330, a decision module 340, and a control module 350.

The collection module 310 may collect a power consumption amount and a usage property from a sub meter, a start meter, and the like, that may read a power consumption amount for each of electronic devices that are installed within a house or an office building.

The storage module 320 may store usage properties including a usage time, a power consumption amount, a power-off availability, a power adjustment availability, whether a temporary stop function is installed, and the like, with respect to each electronic device, based on the collected information.

The analysis module 330 may classify a plurality of electronic devices into “full-time”, “off”, “adjust”, and “stop” groups, based on information stored for each electronic device, and may analyze the average usage time with respect to the classified electronic devices.

To control energy saving within a building, the decision module 340 may calculate a remaining operation time excluding a current actual operation time from the average usage time for each electronic device within the building, and may determine whether to perform a power control.

Based on the determination result of the decision module 340, the control module 350 may power off a predetermined electronic device, may save power by adjusting a temperature, a brightness, and the like of the predetermined electronic device, or may restart the predetermined electronic device after temporary stop.

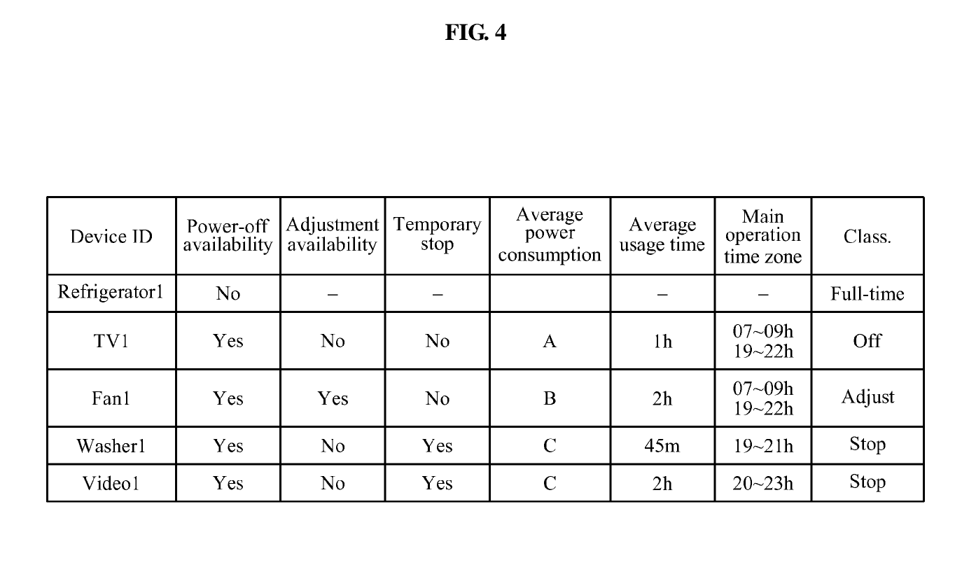

FIG. 4 is a table illustrating a usage property for each electronic device according to an embodiment of the present invention.

The storage module 320 may construct a database based on usage properties collected from electronic devices.

The storage module 320 may construct the database as shown in FIG. 4, based on time information that is collected together with a power consumption amount of each electronic device. Usage property values such as a power-off availability, a power adjustment availability, whether a temporary stop function is installed, and the like, of FIG. 4 may be classified in advance based on a type of an electronic device. Here, even the same type of electronic devices may be differently classified and thus, the storage module 320 may also provide a procedure of registering an electronic device.

The present invention is not limited to a scheme of displaying the average power consumption, the average usage time, and a main operation time zone, a power unit such as w and kw, a time unit such as second, minute, and hour, a time zone unit such as season of summer/winter, each quarter, weekdays/weekends, and a time of second/minute/hour unit, and the like. The average power consumption, the average usage time, and the main operation time zone may be analyzed based on only time information that is collected by the storage module 320 from an electronic device, and thereby be managed.

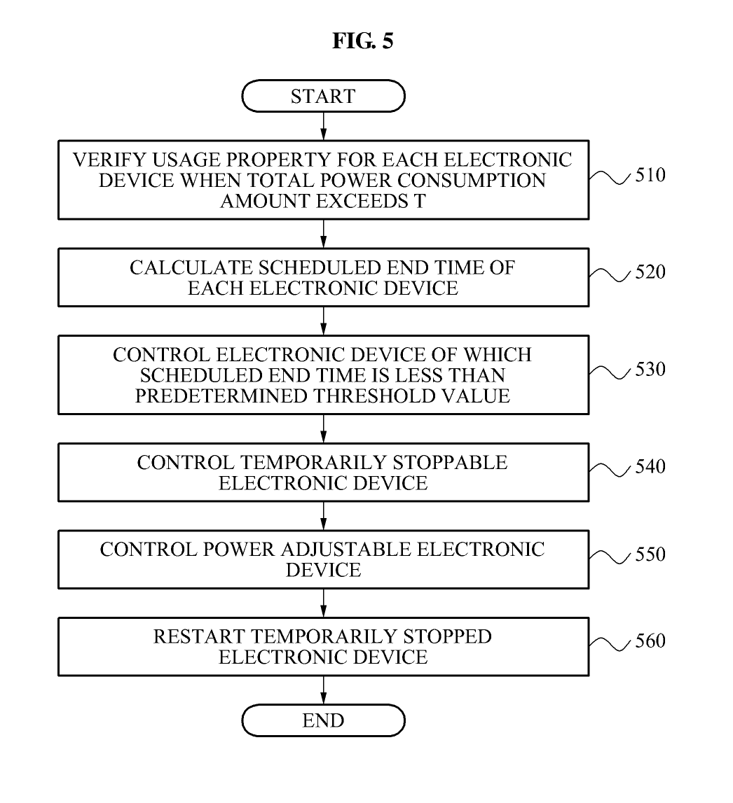

FIG. 5 is a flowchart illustrating an energy control method according to an embodiment of the present invention.

The energy control method may be performed by the energy control apparatus of FIG. 3. Hereinafter, the energy control method of FIG. 5 will be described with reference to FIG. 3.

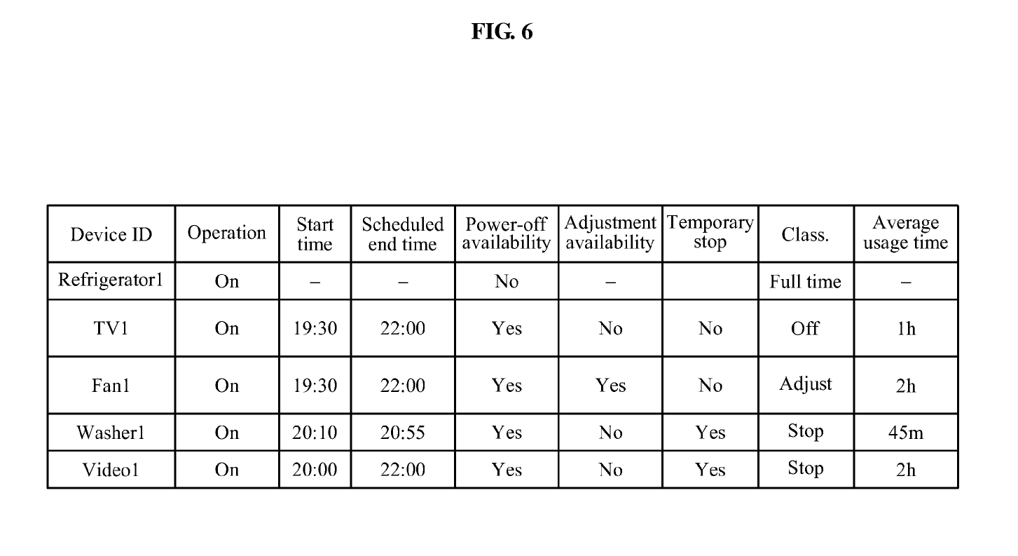

FIG. 6 is a table illustrating a usage time of each electronic device according to an embodiment of the present invention.

It is assumed that a sub meter capable of collecting a power consumption amount for each electronic device within a house or an office building using electric power, and a smart meter of measuring a total power consumption amount within the building are installed, and an energy control apparatus collects and manages a power consumption amount. Also, a power manager may desire a total power amount within the building to be used within a predetermined threshold value T.

In operation 510, the energy control apparatus may calculate a total power consumption amount at predetermined periods, and may verify a usage property for each electronic device when a total power consumption amount collected at 8:30 p.m. is determined to exceed T.

In operation 520, when refrigerator1, TV1, fan1, washer1, and video1 are currently operating, the energy control apparatus may calculate a scheduled end time of each electronic device based on the average usage time of each of remaining electronic devices excluding refrigerator1 of which power-off is unavailable, that is, disallowed, as shown in FIG. 6.

In operation 530, the energy control apparatus may verify the scheduled end time, and may retrieve an electronic device capable of decreasing the power consumption by verifying the remaining electronic devices excluding refrigerator 1 of which scheduled end time is less than the threshold value.

In operation 540, the energy control apparatus may temporarily stop video1 by retrieving a temporarily stoppable electronic device, for example, video1, and by controlling the temporarily stoppable video 1.

In operation 550, when a total power consumption amount is determined to exceed T even after temporarily stopping video1, the energy control apparatus may decrease the power consumption amount by decreasing a temperature of a power-adjustable electronic device, for example, fan1.

In operation 560, the energy control apparatus may retrieve the temporarily stopped electronic device, for example, video1, at a point in time when the total power amount is decreased to be less than T by decreasing the power consumption amount of fan1, and may restart the temporarily stopped video 1.

In the above embodiment, even though a sub meter is not installed in all of the electronic devices, the energy control apparatus may operate by obtaining a power consumption amount through sub meters that are installed in some of electronic devices.

The energy control apparatus may also control a total power consumption amount by providing a control interface through a display apparatus and enabling a user to control power.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An energy control apparatus using a usage property of an electronic device, the apparatus comprising:
a decision module to determine whether to control power of the electronic device by calculating a remaining operation time excluding an actual operation time from the average usage time; and
a control module to control at least one of power-off, adjustment of power consumption, and a restart in a power available time zone after a temporary stop with respect to the electronic device, based on the determination result.

2. The apparatus of claim 1, further comprising:
an analysis module to analyze the average usage time based on the usage property of the electronic device.

3. The apparatus of claim 1, further comprising:
an analysis module to classify the electronic device for each control group based on the usage property of the electronic device,
wherein the control module controls the electronic device by further considering the classified control group.

4. The apparatus of claim 2, further comprising:
a storage module to store, as the usage property, at least one of a usage time of the electronic device, a power consumption amount, a power-off availability, a power adjustment availability, and whether a temporary stop function is installed.

5. The apparatus of claim 1, wherein the control module receives a user control by displaying, on a control interface, at least one of an operability, a start time, a scheduled end time, and a usage property with respect to the electronic device.

6. An energy control method using a usage property of an electronic device, the method comprising:
calculating a scheduled end time based on the average usage time of each first electronic device excluding, from among operating electronic device, an electronic device of which power-off is unavailable;
selecting a second electronic device from among first electronic device based on the scheduled end time; and
controlling at least one of power-off, adjustment of power consumption, and a restart in a power available time zone after a temporary stop with respect to the second electronic device based on a usage property of the second electronic device.

7. The method of claim 6, wherein the selecting comprises selecting, from among the first electronic devices, the second electronic device of which the scheduled end time is greater than or equal to a predetermined threshold.

8. The method of claim 6, wherein when the restart in the power available time zone after the temporary stop is controlled, the controlling comprises:
controlling a temporarily stoppable second electronic device to be temporarily stopped;
controlling a power adjustable second electronic device to decrease a power consumption amount when a total power consumption amount after the temporary stop exceeds a predetermined threshold value; and
starting the temporarily stopped electronic device at a point in time when the total power consumption amount after decreasing the power consumption amount decreases to be less than the threshold value.

9. The method of claim 6, wherein the calculating comprises calculating the scheduled end time at a point in time when a total power amount collected from first electronic devices exceeds a predetermined threshold value.

10. The method of claim 6, further comprising:
setting the average usage time based on usage properties of first electronic devices.
